(19) United States
(12) Patent Application Publication
(10) Pub. No.: US 2020/0133037 A1
(43) Pub. Date: Apr. 30, 2020

(54) CONTROLLABLE BACKLIGHT STRUCTURE AND DISPLAY DEVICE

(71) Applicant: HUIZHOU CHINA STAR OPTOELECTRONICS TECHNOLOGY CO.,LTD., Huizhou Guangdong (CN)

(72) Inventor: Dehua LI, Huizhou Guangdong (CN)

(21) Appl. No.: 15/752,463

(22) PCT Filed: Jan. 18, 2018
(86) PCT No.: PCT/CN2018/073210

§ 371 Date: Feb. 13, 2018

(30) Foreign Application Priority Data
Dec. 28, 2017 (CN) 201711461198.3

(51) Int. Cl. G02F 1/13357

(52) U.S. Cl. CPC G02F 1/1336; G02F 2001/133601

(57) ABSTRACT

The present disclosure discloses a controllable backlight structure and a display device using the structure. The controllable backlight structure includes a liquid crystal panel and a backlight source for providing a light source for the liquid crystal panel, wherein a shutter unit is disposed between the liquid crystal panel and the backlight source, the shutter unit includes a plurality of blades arranged in an array, each blade is connected with at least one rotating mechanism, the rotating mechanism is connected with a control circuit, a rotation of each rotating mechanism opens and closes one blade to control the backlight source to have different incident light in different regions of the liquid crystal panel. The structure of the controllable backlight of the present disclosure is simple and easy to implement. The structure of the controllable backlight with improved image quality of the liquid crystal is simple and easy to be implemented.

### RELATED APPLICATIONS

The present application is a National Phase of International Application Number PCT/CN2018/073210, filed Jan. 18, 2018, and claims the priority of China Application No. 201711461198.3, filed Dec. 28, 2017.

### FIELD OF THE DISCLOSURE

The present disclosure relates to a liquid crystal backlight technology field, and more particularly to a controllable backlight structure and a display device using the structure.

### BACKGROUND OF THE DISCLOSURE

With the development of LCD TVs, LCD TV quality requirements are getting higher and higher. HDR (High-Dynamic Range) through the backlight partition control and LCD contrast to enhance the contrast of the TV screen, improve the quality.

The backlight control scheme and the structure of the existing liquid crystal display device are complex, the power consumption is large, and the energy is not saved.

Therefore, the prior art still needs further development.

### SUMMARY OF THE DISCLOSURE

In view of the above deficiencies of the prior art, the object of the present disclosure is to propose a controllable backlight structure, which aims to solve the problem of the backlight partition control principle and the structure of the prior art liquid crystal display device that the structure is complicated, the power consumption is large, and the energy is not saved.

To achieve the above object, the present disclosure adopts the following technical solutions.

A controllable backlight structure includes a liquid crystal panel and a backlight source for providing a light source for the liquid crystal panel, wherein a shutter unit disposed between the liquid crystal panel and the backlight source, the shutter unit includes a plurality of blades arranged in an array, each blade is connected with at least one rotating mechanism, the rotating mechanism is connected with a control circuit, a rotation of each rotating mechanism opens and closes one blade to control the backlight source to have different incident light in different regions of the liquid crystal panel.

The shutter unit further includes a shutter bracket to which the blade is mounted, and both ends of the blade are rotatably connected to the shutter bracket.

The rotating mechanism is provided at the tip of the blade, the rotating mechanism includes:

a first rotating shaft rotatably connected to the shutter bracket and having one end fixedly connected with the blade;
a coil disposed on the end of the first rotating shaft away from the blade and connected to the control circuit; and
a permanent magnet fixed to the shutter bracket and disposed on both sides of the coil, wherein the magnetic field of the permanent magnet rotates the energized coil.

The rotating mechanism is disposed at the tip of the blade, the rotating mechanism includes:

a first rotating shaft rotatably connected to the shutter bracket and having one end fixedly connected with the blade;
a permanent magnet spaced from the first rotating shaft and fixed to the shutter bracket; a coil disposed outside the permanent magnet and connected with the control circuit to slide relative to the permanent magnet after being electrified; and
a connecting rod, one end of the connecting rod is rotatably connected to one side of the coil, and the other end of the connecting rod is rotatably connected to the end of the first rotating shaft away from the blade.

The rotating mechanism further includes a second rotating shaft, one end of the second rotating shaft is fixed to one end of the blade away from the first rotating shaft, and the other end of the second rotating shaft is rotatably connected to the shutter bracket.

The rotating mechanism further includes an angle sensor provided on the shutter bracket, and the angle sensor is connected to the control circuit to control the rotation angle of the first rotating shaft.

The plurality of blades arranged in an array form a group of blades, the group of the blades are arranged vertically or transversely.

The blades arranged in the plurality of arrays form two groups of the blades, the two groups of the blades are arranged at intervals, including a vertical blade group and a transverse blade group, and the two groups of the blades are both fixed on the shutter bracket.

The transverse blade group is disposed between the liquid crystal panel and the vertical blade group, or the vertical blade group is disposed between the liquid crystal panel and the transverse blade group.

The present disclosure further provides a display device, which includes the above controllable backlight structure.

Beneficial effects: in the controllable backlight structure of the technical solution of the present disclosure, the shutter unit is provided between the liquid crystal panel and the backlight source, the shutter unit includes a plurality of blades arranged in an array, each blade is connected with at least one rotating mechanism, each rotating mechanism is rotated to open and close a blade, the corresponding positions of the plurality of blades of the shutter unit divide the backlight source into a plurality of zones, the rotation of each of the blades is turned on and off separately, so that the backlight source has different incident lights in different regions of the liquid crystal panel to realize the partition control of the backlight source. At the same time, the blade opening and closing angles can also be individually controlled to meet the needs of different contrast display images, the controllable backlight structure is simple and easy to achieve, while improving the liquid crystal image screen display, while low power consumption, which is conducive to energy saving.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely some embodiments of the present disclosure, and persons of ordinary skill in the art may still derive other drawings from the structures shown in these accompanying drawings without creative efforts.

FIG. 1 is a schematic diagram of an exploded structure of Embodiment 1 of a controllable backlight structure according to the present disclosure.

FIG. 2 is a schematic structural diagram of Embodiment 1 of a rotating mechanism of a controllable backlight structure of the present disclosure.

FIG. 3 is a schematic structural diagram of Embodiment 2 of the rotating mechanism of the controllable backlight structure of the present disclosure.

FIG. 4 is another schematic diagram of the structure of FIG. 3.

FIG. 5 is an enlarged schematic diagram of A in FIG. 1.

FIG. 6 is a schematic diagram of the controllable backlight structure of a blade open state of FIG. 1.

FIG. 7 is a schematic diagram of an exploded structure of Embodiment 2 of a controllable backlight structure according to the present disclosure.

FIG. 8 is a schematic diagram of the two blades of the controllable backlight structure in FIG. 7 being opened.

### EXPLANATION OF REFERENCE NUMERALS

| Label | Name |
|---|---|
| 10 | Liquid crystal panel |
| 20 | Backlight source |
| 30 | Shutter unit |
| 40 | Blade |
| 50 | Rotating mechanism |
| 51 | First rotating shaft |
| 52 | Coil |
| 53 | Permanent magnet |
| 54 | Connecting rod |
| 55 | Second rotating shaft |
| 60 | Shutter bracket |
| 70 | Group of blades |
| 71 | Vertical blade group |
| 72 | Transverse blade |
| | group |

The realization, the function and the advantages of the object of the present disclosure will be further described with reference to the accompanying drawings with reference to the accompanying drawings.

### Detailed Description of Preferred Embodiments

The technical solution in the embodiments of the present disclosure will be described clearly and completely hereinafter with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

It should be noted that, all the directional indications (such as up, down, left, right, front, back . . . ) in the embodiments of the present disclosure are only used to explain the relative position relationship, the movement condition, and the like of the components in a specific posture (as shown in the drawings). If the specific gesture changes, the directivity indication also changes accordingly.

In the present disclosure, the terms “connected”, “fixed” and the like should be broadly understood unless expressly stated and limited otherwise. For example, “fixed” may be a fixed connection, a detachable connection, or a single body; it may be a mechanical connection or an electrical connection; it may be directly connected or indirectly connected through an intermediary medium. It may be an internal communication between two components or an interaction between two components unless otherwise explicitly defined. For those skilled in the art, the specific meanings of the above terms in the present disclosure may be understood based on specific situations.

In addition, the description of the “first”, the “second”, and the like in the present disclosure are merely for the purpose of description and are not to be construed as indicating or implying any relative importance or implied reference to the number of indicated technical features. Thus, features defining “first” and “second” may explicitly or implicitly include at least one of the features. In addition, the technical solutions between the various embodiments may be combined with each other, but must be based on the implementation that can be implemented by a person of ordinary skill in the art. When the combination of technical solutions appears contradictory or unrealizable, it should be considered that the combination of such technical solutions does not exist and is not within the protection scope of the present disclosure.

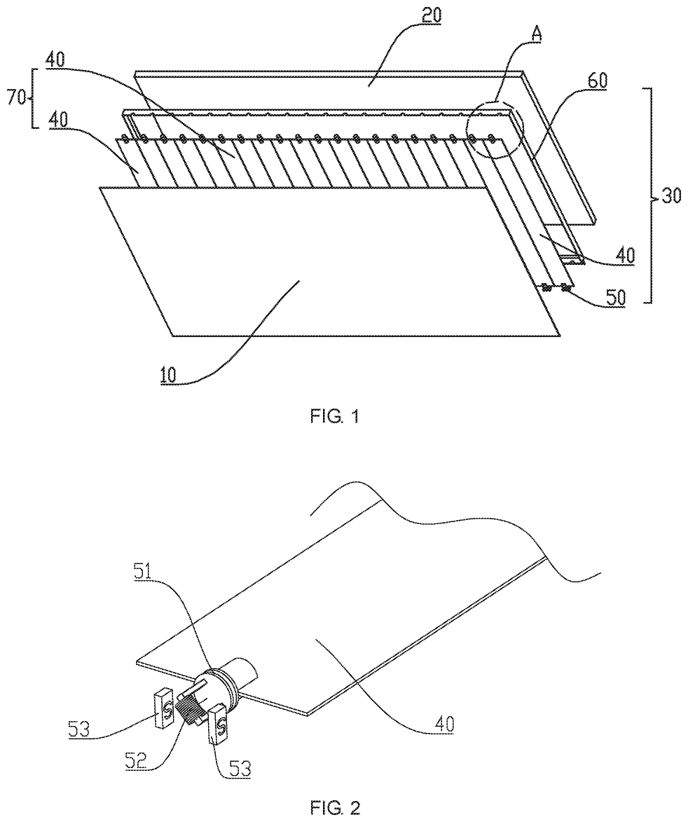

Referring to FIG. 1 to FIG. 5, the present disclosure provides a controllable backlight structure, including a liquid crystal panel 10, and a backlight source 20 that provides a light source for the liquid crystal panel 10, wherein a shutter unit 30 is disposed between the liquid crystal panel 10 and the backlight source 20. The shutter unit 30 includes a plurality of blades 40 arranged in an array. Each blade 40 is connected to at least one rotating mechanism 50. the rotating mechanism 50 is connected to the control circuit, and the rotation of each of the rotation mechanisms 50 opens and closes a blade 40 to control the backlight source 20 to have different incident light in different regions of the liquid crystal panel 10.

In the embodiment of the present disclosure, the control circuit controls the rotation of each rotating mechanism to drive the blade to rotate according to the requirement of the picture display. When the screen needs to be bright where the blades open, when the dark screen where the screen is required to close the blades, make the screen darker areas darker, lighter areas brighter, so that the contrast of the screen significantly improve the quality of the LCD TV to improve display.

In the technical solution of the present disclosure, the shutter unit is disposed between the liquid crystal panel and the backlight source, the shutter unit includes a plurality of blades arranged in an array, each blade is connected with at least one rotating mechanism, each rotating mechanism is rotated to open and close a blade, the corresponding positions of the plurality of blades of the shutter unit divide the backlight source into a plurality of zones, the rotation of each of the blades is turned on and off separately, so that the backlight source has different incident lights in different regions of the liquid crystal panel to realize the partition control of the backlight source. The structure of the controllable backlight is simple and easy to realize, and while improving the display quality of the liquid crystal image, the power consumption is low, which is good for energy saving.

As shown in FIG. 1, in the embodiment of the present disclosure, the shutter unit 30 further includes a shutter bracket 60 to which the blade is mounted. Both ends of the blade 40 are rotatably connected to the shutter bracket 60. As an embodiment, a plurality of blade mounting holes may be provided at both ends of the shutter bracket 60, both ends of the blade 40 are mounted on the mounting holes of the shutter bracket 60. The blade 40 is rotated on the mounting hole of the shutter bracket by the rotating mechanism 50.

Specifically, as shown in FIG. 1 and FIG. 2, the rotating mechanism 50 is disposed at the tip of the blade 40, and includes:

a first rotating shaft 51 rotatably connected to the shutter bracket 60 and has one end fixedly connected with the blade 40. The first rotating shaft and the blade can be connected by means of clamping, bolting, or riveting.
a coil 52 disposed on the end of the first rotating shaft 51 away from the blade 40 and connected to the control circuit; and
a permanent magnet 53 fixed to the shutter bracket 60 and provided on both sides of the coil 52. The magnetic field of the permanent magnet 53 rotates the coil 52 that has been energized.

When the HDR signal passes through the coil on the first rotating shaft, the coil deflects and drives the first rotating shaft to rotate under the action of the magnetic field on both sides. Finally, the blade is rotated to realize the control of the opening and closing blades. As shown in FIG. 6, when the backlight source is turned on and then a blade rotation of the shutter unit is in an open state, where the intersection of the two is the place where the backlight source is incident, as shown in the B position in the figure, meanwhile, the blade at position B rotates and is perpendicular to the plane of the backlight source.

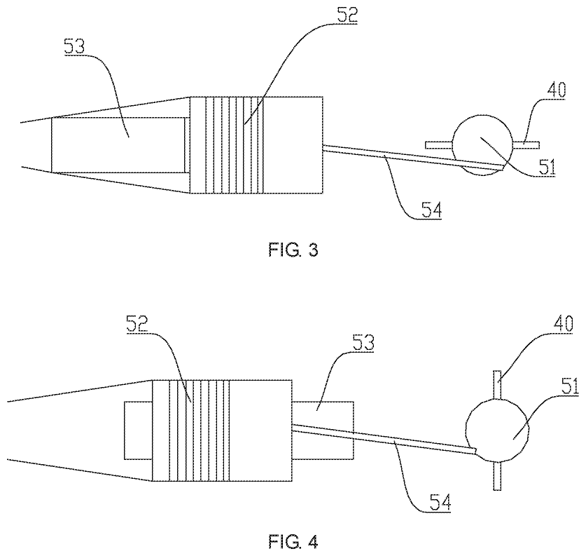

As another embodiment of the rotating mechanism 50, as shown in FIGS. 3 and 4, the rotating mechanism 50 is provided at the tip of the blade 40 and includes:

a first rotating shaft 51 rotatably connected to the shutter bracket 60 and has one end fixedly connected with the blade 40;
a permanent magnet 53 spaced from the first rotating shaft 51 and fixed to the shutter bracket 60;
a coil 52 is sleeved outside the permanent magnet 53. The coil 52 is connected to the control circuit and slides relative to the permanent magnet 53 when energized; and a connecting rod 54, one end of the connecting rod 54 is rotatably connected to one side of the coil 52, and the other end of the connecting rod 54 is rotatably connected to an end of the first rotating shaft 51 away from the blade 40.

In this embodiment, since the first rotating shaft is mounted on the tip of the blade, the coil is sheathed into the permanent magnet, when the HDR signal is passed into the coil, the coil moves in the axial direction of the permanent magnet, the coil drives the connecting rod to move, and the connecting rod drives the first rotating shaft to rotate so that the blades rotate so as to control the opening and closing of the blades.

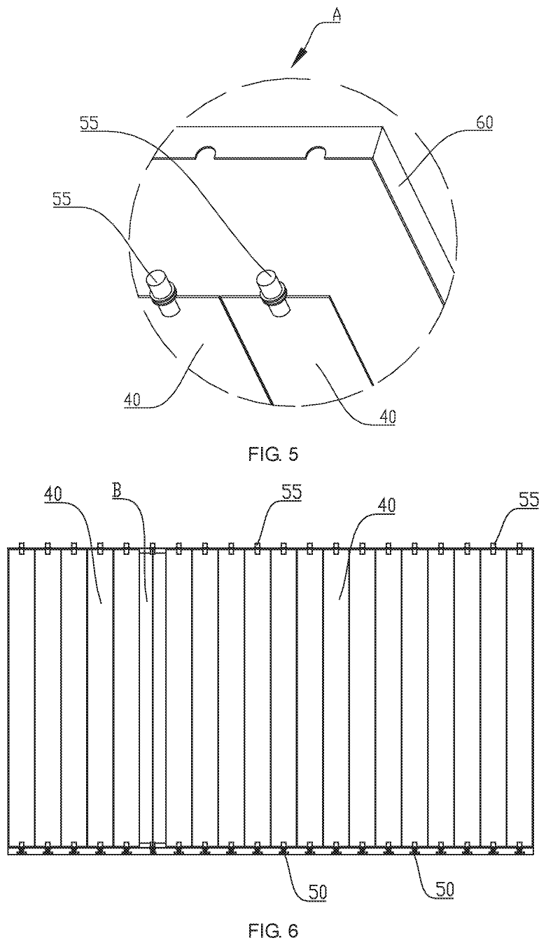

Please refer to FIG. 1 and FIG. 5, the rotating mechanism 50 further includes a second rotating shaft 55. One end of the second rotating shaft 55 is fixed to one end of the blade 40 away from the first rotating shaft 51, and the other end of the second rotating shaft 55 is rotatably connected to the shutter bracket 60. The second rotating shaft 55 is provided for smooth rotation of the blade.

Further, the rotating mechanism 50 further includes an angle sensor (not shown) disposed on the shutter bracket and connected to the control circuit to control the rotation angle of the first rotating shaft. Angle sensor and control circuit combined with the control of the blade opening and closing angle, and further control of each region of the light source of the incident intensity, in order to enhance the display contrast control screen.

In the present embodiment of the present disclosure, a plurality of arrays of blades 40 arranged in an array may be arranged in groups, as one of the embodiments, as shown in FIG. 1, the plurality of blades 40 arranged in an array form a group of blades 70, which are vertically disposed or transversely disposed.

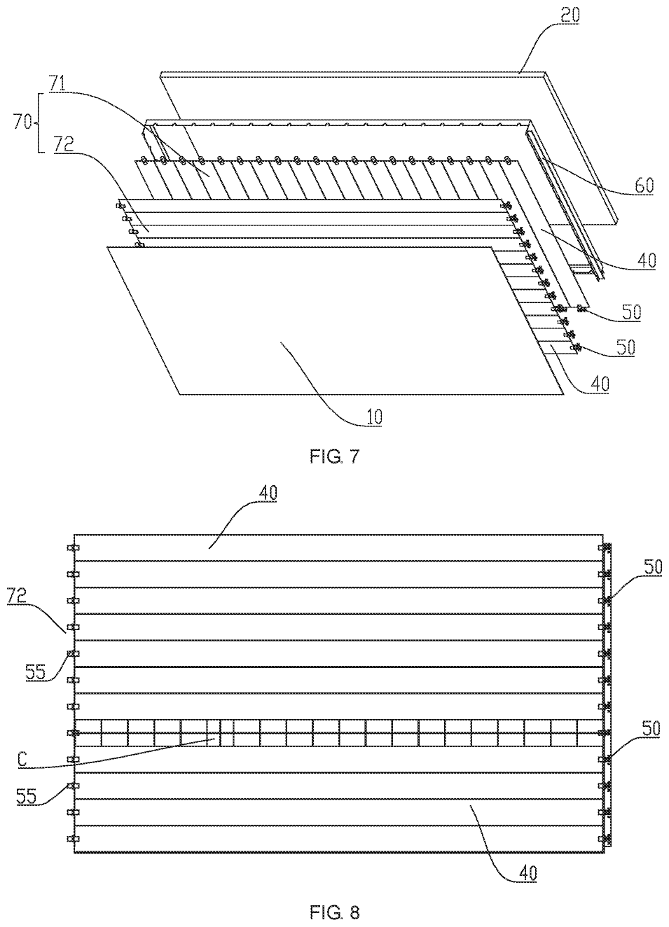

In another embodiment, as shown in FIG. 7, the blades 40 arranged in a plurality of arrays form two groups of blades 70. The two groups of blades are spaced apart and include a vertical blade group 71 and a transverse blade group 72. Both of the blade groups are fixed to the shutter bracket 60. Through two groups of linkage control linkage to further improve the screen display.

As one arrangement of the two vane groups, the transverse blade group 72 is disposed between the liquid crystal panel 10 and the vertical blade group 71; as shown in FIG. 8, when the backlight source is turned on, a blade 40 of the transverse blade group 72 is rotated in an open state, a blade 40 of the subsequent vertical blade group 71 rotates in an open state, at the intersection of the two blades, the place where the backlight source is incident, as shown in the C position, at this time, the vertical blades at the position of the transverse blades in the position C rotate and are perpendicular to the plane of the backlight source.

Of course, the vertical blade group 71 is disposed between the liquid crystal panel 10 and the transverse blade group 72 as another arrangement of the two blades group.

It can be understood that in other embodiments of the present disclosure, a plurality of groups of blades arranged in an array may also be disposed between the liquid crystal panel and the backlight source. For example, three groups of blades and four groups of blades may be disposed and may be selectively configured according to design requirements.

The present disclosure further provides a display device (not shown), which includes the above controllable backlight structure. The specific structure of the controllable backlight structure refers to the above embodiment.

Since all the technical solutions of the above-mentioned controllable backlight structure are adopted by the display device, at least all the benefits brought by the technical solutions of the above embodiments are not repeated herein.

The foregoing descriptions are merely preferred embodiments of the present disclosure, and do not limit the scope of the present disclosure. All equivalent structural transformations made by using the contents of the specification and drawings of the present disclosure or direct/indirect applications under the inventive concept of the present disclosure are all included in the scope of the present patent protection in other related technical fields.

What is claimed is:

1. A controllable backlight structure, comprising a liquid crystal panel and a backlight source for providing a light source for the liquid crystal panel, a shutter unit disposed between the liquid crystal panel and the backlight source, wherein the shutter unit comprises a plurality of blades arranged in an array, each blade is connected with at least one rotating mechanism, the rotating mechanism is connected with a control circuit, a rotation of each rotating mechanism opens and closes one blade to control the backlight source to have different incident light in different regions of the liquid crystal panel.

2. The controllable backlight structure according to claim 1, wherein the shutter unit further comprises a shutter bracket to which the blade is mounted, and both ends of the blade are rotatably connected to the shutter bracket.

3. The controllable backlight structure according to claim 2, wherein the rotating mechanism is provided at a tip of the blade, and the rotating mechanism comprises:
a first rotating shaft rotatably connected to the shutter bracket and having one end fixedly connected with the blade;
a coil disposed on an end of the first rotating shaft away from the blade and connected to the control circuit; and
a permanent magnet fixed to the shutter bracket and disposed on both sides of the coil, wherein a magnetic field of the permanent magnet rotates the energized coil.

4. The controllable backlight structure according to claim 3, wherein the rotating mechanism further comprises a second rotating shaft, one end of the second rotating shaft is fixed to one end of the blade away from the first rotating shaft, and the other end of the second rotating shaft is rotatably connected to the shutter bracket.

5. The controllable backlight structure according to claim 3, wherein the rotating mechanism further comprises an angle sensor provided on the shutter bracket, and the angle sensor is connected to the control circuit to control a rotation angle of the first rotating shaft.

6. The controllable backlight structure according to claim 2, wherein the rotating mechanism is disposed at the tip of the blade, and the rotating mechanism comprises:
a first rotating shaft rotatably connected to the shutter bracket and having one end fixedly connected with the blade;
a permanent magnet spaced from the first rotating shaft and fixed to the shutter bracket;
a coil disposed outside the permanent magnet and connected with the control circuit to slide relative to the permanent magnet after being electrified; and
a connecting rod, one end of the connecting rod is rotatably connected to one side of the coil, and the other end of the connecting rod is rotatably connected to an end of the first rotating shaft away from the blade.

7. The controllable backlight structure according to claim 6, wherein the rotating mechanism further comprises a second rotating shaft, one end of the second rotating shaft is fixed to one end of the blade away from the first rotating shaft, and the other end of the second rotating shaft is rotatably connected to the shutter bracket.

8. The controllable backlight structure according to claim 6, wherein the rotating mechanism further comprises an angle sensor provided on the shutter bracket, and the angle sensor is connected to the control circuit to control a rotation angle of the first rotating shaft.

9. The controllable backlight structure according to claim 2, wherein the plurality of blades arranged in an array form a group of blades, the group of the blades are arranged vertically or transversely.

10. The controllable backlight structure according to claim 2, wherein the blades arranged in the plurality of arrays form two groups of the blades, the two groups of the blades are arranged at intervals, comprising a vertical blade group and a transverse blade group, and the two groups of the blades are both fixed on the shutter bracket;
wherein the transverse blade group is disposed between the liquid crystal panel and the vertical blade group, or the vertical blade group is disposed between the liquid crystal panel and the transverse blade group.

11. A display device, comprising a controllable backlight structure, the controllable backlight structure comprises a liquid crystal panel and a backlight source for providing a light source for the liquid crystal panel, a shutter unit disposed between the liquid crystal panel and the backlight source, wherein the shutter unit comprises a plurality of blades arranged in an array, each blade is connected with at least one rotating mechanism, the rotating mechanism is connected with a control circuit, a rotation of each rotating mechanism opens and closes one blade to control the backlight source to have different incident light in different regions of the liquid crystal panel.

12. The display device according to claim 11, wherein the shutter unit further comprises a shutter bracket to which the blade is mounted, and both ends of the blade are rotatably connected to the shutter bracket.

13. The display device according to claim 12, wherein the rotating mechanism is provided at a tip of the blade, and the rotating mechanism comprises:
a first rotating shaft rotatably connected to the shutter bracket and having one end fixedly connected with the blade;
a coil disposed on an end of the first rotating shaft away from the blade and connected to the control circuit; and
a permanent magnet fixed to the shutter bracket and disposed on both sides of the coil, wherein a magnetic field of the permanent magnet rotates the energized coil.

14. The display device according to claim 13, wherein the rotating mechanism further comprises a second rotating shaft, one end of the second rotating shaft is fixed to one end of the blade away from the first rotating shaft, and the other end of the second rotating shaft is rotatably connected to the shutter bracket.

15. The display device according to claim 13, wherein the rotating mechanism further comprises an angle sensor provided on the shutter bracket, and the angle sensor is connected to the control circuit to control a rotation angle of the first rotating shaft.

16. The display device according to claim 12, wherein the rotating mechanism is disposed at the tip of the blade, and the rotating mechanism comprises:
a first rotating shaft rotatably connected to the shutter bracket and having one end fixedly connected with the blade;
a permanent magnet spaced from the first rotating shaft and fixed to the shutter bracket;
a coil disposed outside the permanent magnet and connected with the control circuit to slide relative to the permanent magnet after being electrified; and
a connecting rod, one end of the connecting rod is rotatably connected to one side of the coil, and the other end of the connecting rod is rotatably connected to an end of the first rotating shaft away from the blade.

17. The display device according to claim 16, wherein the rotating mechanism further comprises a second rotating shaft, one end of the second rotating shaft is fixed to one end of the blade away from the first rotating shaft, and the other end of the second rotating shaft is rotatably connected to the shutter bracket.

18. The display device according to claim 16, wherein the rotating mechanism further comprises an angle sensor provided on the shutter bracket, and the angle sensor is connected to the control circuit to control a rotation angle of the first rotating shaft.

19. The display device according to claim 12, wherein the plurality of blades arranged in an array form a group of blades, the group of the blades are arranged vertically or transversely.

20. The display device according to claim 12, wherein the blades arranged in the plurality of arrays form two groups of the blades, the two groups of the blades are arranged at intervals, comprising a vertical blade group and a transverse blade group, and the two groups of the blades are both fixed on the shutter bracket;
wherein the transverse blade group is disposed between the liquid crystal panel and the vertical blade group, or the vertical blade group is disposed between the liquid crystal panel and the transverse blade group.
